(19) United States
(12) Patent Application Publication
(10) Pub. No.: US 2007/0165865 A1
(43) Pub. Date: Jul. 19, 2007

(54) Method and system for encryption and storage of information

(76) Inventor: Jarmo Talvitie, Tuusula (FI)

Correspondence Address: YOUNG & THOMPSON, 745 SOUTH 23RD STREET, 2ND FLOOR, ARLINGTON, VA, 22202, US

(21) Appl. No.: 10/557,113

(22) PCT Filed: May 14, 2004
(86) PCT No.: PCT/FI04/00291

§ 371 Date: Dec. 11, 2006

(30) Foreign Application Priority Data
May 16, 2003 (FI) 20030745

(51) Int. Cl. H04L 9/00

(52) U.S. Cl. 380/286

(57) ABSTRACT

The invention relates to a method and system for data encryption implemented in conjunction with data transmission over a communications network. According to the invention, an electronic message can be split into at least two parts that are individually forwarded to a receiver (126) via different identities (104, 106, 108, 110). The identities are, e.g., e-mail addresses, servers, subscriber connections or user identifiers. The selection of the identities, advantageously of a concealed character, can be made from a larger group of identities and may be varied on a per message, session or timed basis. Also in the receiving direction of the message it is possible to use plural different identities (114, 116, 118, 120) in the reception of a message. The received parts of the message can be identified among other traffic flow and subsequently combined with each other using key information. The arrangement disclosed herein may also be applied to data storage.

The invention relates to an encryption and storage scheme of information that is transferable over a communications network and is stored on a computer.

In a general case, information may be encrypted using, e.g., either a public- or a private-key algorithm. The securing efficiency of a private-key algorithm is grossly based on the assumption that the algorithm's method of operation is not known to a possibly attacking hacker. However, inasmuch as even confidential information sooner or later tends to end up in wrong hands, private-key algorithms have lately had to give way to public-key algorithms that are broadly considered safer.

The use of a public-key algorithm is based on a mathematical function commonly recognized and known to be reliable when used in combination with a separate encryption key. In such a case, security can be achieved only with the precondition that the encryption key remains private. Traditionally, messages transmitted over communications networks are encrypted using either symmetric or asymmetric encryption algorithms. Symmetric encryption is the older one of these two alternatives, and it refers to algorithms that use the same encryption key in both the encryption of information and in decryption, also known as the inversion process. As a rule, symmetric encryption algorithms are computationally less demanding than asymmetric algorithms, but on the other hand, also easier to crack. The encryption power of a symmetric encryption algorithm is based on both the complexity of the mathematical transform used and on the length of the encryption key. A longer encryption key gives a higher level of protection. Symmetric encryption algorithms include, among others: DES (Digital Encryption Standard), AES (Advanced Encryption Standard) and RC4 (Ron's Code 4) developed by Ron Rivest. In the basic version of DES, for example, the key length is 56 bits, resulting in 2⁵⁶ different encryption keys. The use of a symmetric encryption poses the problem of how to transfer the key over an insecure connection. Most implementations are based on cooperation with some trusted authenticator. An increasing number of users will also readily cause an excessive increase in the number of keys inasmuch as every pair of users will need their own key in order to exchange messages with mutual privacy. As a result a number of n users needs n(n−1)/2 keys, whereby for instance each group of 100 users requires 4950 keys.

The concept of asymmetric encryption was introduced in the 1970s (Diffie & Hellman), followed by the disclosure of the best-known asymmetric encryption algorithm RSA, named after its developers Rivest, Shamir and Adleman. The basic concept of the asymmetric encryption method is that different kinds of keys are used in the encryption and decryption of information. One of the keys is a so-called public key and the other one a so-called private key. Information encrypted with a public key, which can be kept publicly available, can be inversely decrypted only by using a corresponding private key. The security provided by the encryption algorithm is based on the fact that, being a mathematical function, the encryption process itself is easy to perform, while the inverse of the algorithm is very difficult to carry out. Herein, knowing one key is not of much help in deciphering the other. The aforementioned mathematical function may be based, for example, on a discrete logarithm (Diffie-Hellman) or on the difficulty in factoring large numbers into their primes (RSA). In private communication taking place, for instance, over the Internet, this asymmetric encryption is often realized such a way that the recipient openly discloses on his own web page (Word Wide Web, WWW) his public key, which the sender then uses to encrypt the message to be sent. Once the recipient has received the message encrypted with the public key, he can decrypt the text using a private key known only by himself.

Asymmetric encryption may cause problems mainly in situations where the origin of the keys is not very well known. To verify the origin of a key, one can turn to a trusted third party that issues a certificate authenticating a desired party. The certificate contains the public key of the chosen party, identifier data and a digital signature made using a private signature key. The digital signature can be verified with the signer's public key, whereby one can be assured of the authenticity of the public key used by the chosen party in his message with the provision that the maker of the signature is trusted. Due to the relatively heavy computational complexity of asymmetric encryption especially when applied to large files, the most commonly employed encryption program of e-mail messages, PGP (Pretty Good Privacy), complements asymmetric encryption (>1000-bit RSA) with symmetric encryption (IDEA, International Data Encryption Algorithm). For each encryption session, a symmetrical encryption key is generated and used to encrypt the message itself, while, one the other hand, a session key is encrypted asymmetrically. Both the message encrypted with the symmetric session key and the asymmetrically-encrypted session key are sent to the recipient.

Asymmetric encryption solves some of the problems associated with the symmetric encryption. A public key can be readily transferred over a insecure connection because it is public anyway. Furthermore, the number of keys remains relatively small since everybody can use the same public key when sending messages to a given user. Asymmetric encryption can be used to digital signatures and authentication. Problems of asymmetric encryption include, among others, slow performance due to the complexity of the algorithms and the typically long length of the keys.

Relying on mathematical means alone does not necessarily guarantee encryption that is one hundred percent unforgeable. If forgery of the decrypted information is attempted by simple “brute-force” techniques through systematical probing with different key alternatives, in principle this could be successful with the provision that the computer means are powerful enough and there is enough time available for testing all the different key alternatives. However, a majority of modern encryption algorithms are based on such complex mathematics that the average user cannot be assumed to fully understand or cover the full extent of their protective capability or possible risk factors. Such security risk unknown to the user tend to lessen the general trust to the confidentiality of electronic communication.

It is an object of the invention to increase the security of data transmission over communications networks by providing a novel arrangement for the data encryption usable in parallel with existing encryption methods. In this arrangement, the message to be sent is splitted advantageously into two or more parts which are sent and possibly even received via two or more concealed servers. A party that illegally has captured a part of a message cannot decrypt the full message inasmuch as the other parts of the message are not available. If the number of concealed servers used is sufficiently large, tracing the message parts can be made extremely difficult, since in such an environment the first task is to identify the right servers from the hoard of operating servers and, secondly, to find the right messages (that is, right message parts), whereby it is also necessary to know the information how to assemble the message parts with each other. Complementary to the above arrangement, the original message may further be encrypted by using a known encryption technique, either before or after it is divided into parts. Conversely, one can also apply an arrangement that utilizes only some features of the solution. For instance, messages can be left undivided to be simply sent via a concealed server, or correspondingly, a message can be divided into parts and be sent at least partially via public servers. The afore-presented arrangement can also be applied to the storage of information.

By virtue of the present invention, the level of protection of a system can be elevated or alternatively, a desired protection level can be attained using encryption keys that are shorter than those of the prior art, in which case the transmission capacity of a connection can be enhanced inasmuch as the length of the key generally dictates the amount of calculation needed. The present arrangement can also be used for establishing a network connection with another party in such a way that the recipient has less possibilities than usual to intrude the contacting party's data system or re-establish the connection by himself after the termination of a session. Furthermore, the arrangement disclosed herein is easy to comprehend as compared with traditional encryption methods, which will improve trust in the security of data transmission inasmuch as even a so-called layman user can broadly understand the basics of this security arrangement.

An embodiment of the encryption method according to the invention comprises an arrangement where data is transferred from a sender to a receiver over a communications network, the method being characterized by the steps of
splitting the data into at least two parts in a fashion substantially unrelated to the data content, the parts being individually recognizable and connectable with each other by means of key information, and
sending the parts independently via different identities available in the arrangement, the identities belonging substantially to at least one of the types: server, subscription, address, user identifier.

It is still another object of the invention to provide a system for encryption of data to be transmitted over a communications network, the system comprising means for data storage, means for data processing and means for data transfer between the system and a network element functionally connected with the system, the system being characterized in that it is arranged to split a data entity into at least two parts in a fashion substantially unrelated to the data content, the parts being individually recognizable and connectable with each other by means of key information, and to send the parts independently via different identities, the identities substantially belonging to at least one of the types: server, subscription, address, user identifier.

It is another further object of the invention to provide a system for reception of data transmitted over a communications network, the system comprising means for data storage, means for data processing and means for data reception from a network element functionally connected with the system, the system being characterized in that it is arranged to receive data that transmitted via at least two different identities and comprised of a data entity splitted into at least two parts in a fashion substantially unrelated to the data content, the identities substantially belonging to at least one of the types: server, subscription, address, user identifier, and furthermore the system being arranged to identify the message parts and combine the same with each other with the help of key information.

It is still another further object of the invention to provide a system for reception of data transmitted over a communications network, the system comprising means for data storage, means for data processing and means for data reception from a network element functionally connected with the system, the system being characterized in that it is arranged to receive data sent from at least two different identities and comprised of a data entity splitted into at least two parts, the identities substantially belonging to at least one of the types: server, subscription, address, user identifier, and furthermore the system being arranged to identify the message parts and combine the same with each other with the help of key information, and still furthermore the system being arranged to receive the data entity parts from at least two different identities which have the data entity parts addressed thereto and substantially belong to at least one of the types: server, subscription, address, user identifier.

It is another further object of the invention to provide a method for automated, distributed storage of data in an electronic system, the method being characterized by the steps of
splitting a data element to be stored into at least two parts in a fashion substantially unrelated to the data content, and
transferring the data element parts to a storage system for storing the data element parts individually into storage units included in a group of available storage units.

It is still another object of the invention to provide a system for data storage, the system comprising means for data processing and means for data transfer between the system and storage equipment functionally connected with the system, the system being characterized in that it is arranged to split a data element into at least two parts in a fashion substantially unrelated to the data content and to transfer the data element parts to a storage system for individually storing the data element parts into storage units included in a group of available storage units.

At least a portion of the above-mentioned identities serving to send or receive the parts of the data entity message may in specific cases be understood to be included in the transmitting (and/or receiving) system. In an arrangement having, e.g., the originating transmitter (and/or receiver), in practice the terminal equipment thereof, integrated with the apparatus performing the message splitting (and/or reconstruction), also the connection, address and user identities are flexibly integrateable in the sending (and/or receiving) system. On the other hand, if the server identity for instance is trusted to a external service provider, it may as well be understood to be adapted integrally functional with the sending (and/or receiving) system in the spirit of the arrangement according to the invention without physically having the server identity integrated with the sending (and/or receiving) system.

In the present text, the term “message” is used when reference is made to an e-mail message, a file, a computer program or the like information that is transmissible in electronic form over a communications network.

The term “concealed server” refers to a server whose association with the sending/receiving party should remain hidden. The alternatives are: the server address is made nonpublic/concealed and/or dynamic, whereby the owner of the server may be nonpublic or public. The server provider can be, e.g., a cover company, operator or any other party trusted by the message sender/receiver. The level of protection can be adjusted by the number of concealed servers or (dynamic) addresses, plus through the names of the server owners. A concealed server may also be a server that alone or in combination with several other servers is/are controlledly or randomly selected from a large number of servers that are intended to serve a large number of users and have global names/addresses (e.g., the servers of an operator). In the latter case the level of protection is determined by the overall number of servers, the number of servers selected and whether the owner of the servers is public or nonpublic (whereby making the identity of the server owner nonpublic hardly gives further merit in the present arrangement, but may anyhow cause an additional obstacle to an unauthorized party).

The term “concealed subscription” herein refers to a subscription (subscriber connection) that operates via the subscriber's conventional telephone connection and is in a case-by-case fashion defined to have an identity hidden from operators and/or other network clients.

The term “server identity key” refers to information on servers whose outgoing messages are forwarded. Servers in the system are either concealed or unconcealed (a priori at least some of them are concealed). A server identity key is used alone or in conjunction with an identification and/or combination (desplitting) key. Advantageously, a server identity key is never intended to be used alone when the target is to encrypt a message. Obviously, it may be used as the sole key, chiefly to provide protection to user privacy. A server identity key is applicable to make certain types of connections confidential, whereby the function of a server identity key can be negotiated on a per case basis, e.g., according to the following rules:
a) authenticity of the message requires that (one) part of the message is received from each one of the servers defined in the server identity key;
b) authenticity of the message requires that the part(s) of the message is/are received from servers defined in the server identity key;
c) authenticity of the message is guaranteed only if the message identification and/or desplitting key is/are received from a server defined in the server identity key; and/or
d) the sender cannot repudiate a message if the message identification and/or desplitting key are received from a server defined in the server identity key (with the assumption that all other conditions of nonrepudiation are fulfilled). In a similar fashion, the nonrepudiation condition may also be applicable in the other cases listed above (e.g., for items a-c).

The term “identification key” refers to information required for recognition of the correct parts of a message, whereby the correct message parts can be sorted apart from the group of received messages and simultaneously different messages received from one and the same sender can be separated from each other.

The term “combination key” (˜desplitting key) refers to information on the reconstruction process of a message from its data parts.

The term “certificate” refers to authenticity certification digitally signed by a trusted third party stating that a given public key belongs to a given user of the key. In addition to the authenticity certificate of the public key, the certificate contains supplementary information such as name data, issue date of the certificate, expiry date of the certificate, individual serial number, etc. Among this information, the server identity certificate is a certificate constructed to guarantee to secure communications with a given server, whereby the user is assured of communications with an established server, that is, a server of an actual identity.

According to a preferred embodiment of the invention, a system is established for sending messages over a public communications network from a sender to a receiver. The sender and/or receiver may utilize concealed servers in the communication of messages. Advantageously in the sender's mail server, the message is splitted into parts that are sent via separate servers over the public communications network to the receiver's concealed servers and therefrom further to the receiver's mail server to be reconstructed therein and sent therefrom to the receiver's system.

According to a second preferred embodiment of the invention, a call that also may take place between mobile terminals is communicated in a splitted fashion via at least two subscriptions to the receiver who may respectively communicate via plural subscriptions.

According to a third preferred embodiment of the invention, a computer system is utilized to store data entities such as documents and other like files in a distributed fashion in separate storage media, e.g., two or more hard discs that may be located apart from each other. Herein, the one storage unit may be situated, e.g., integral with the computer system while the other storage unit is displaced at a distance needing communications over a network connection.

The preferred embodiments of the invention are described in the dependent Claims.

In the following, the invention is described in a greater detail by making reference to the appended drawings in which

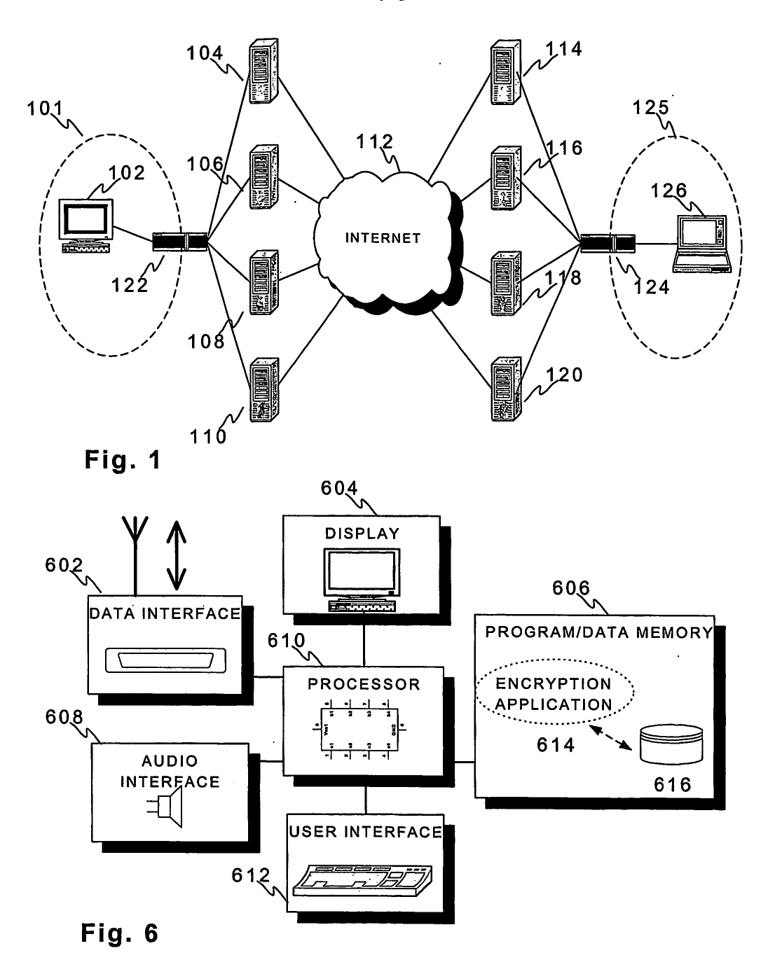

FIG. 1 shows an outline diagram of a system according to the invention for data encryption, the system comprising a message sender's terminal connected to functionally cooperate with a group of sending-end concealed servers via the sending-end mail server, a global communications network for transmission of a message between sending-end and receiving-end devices, and a group of receiving-end concealed servers connected to functionally cooperate via a receiving-end mail server with a message receiver's terminal device;

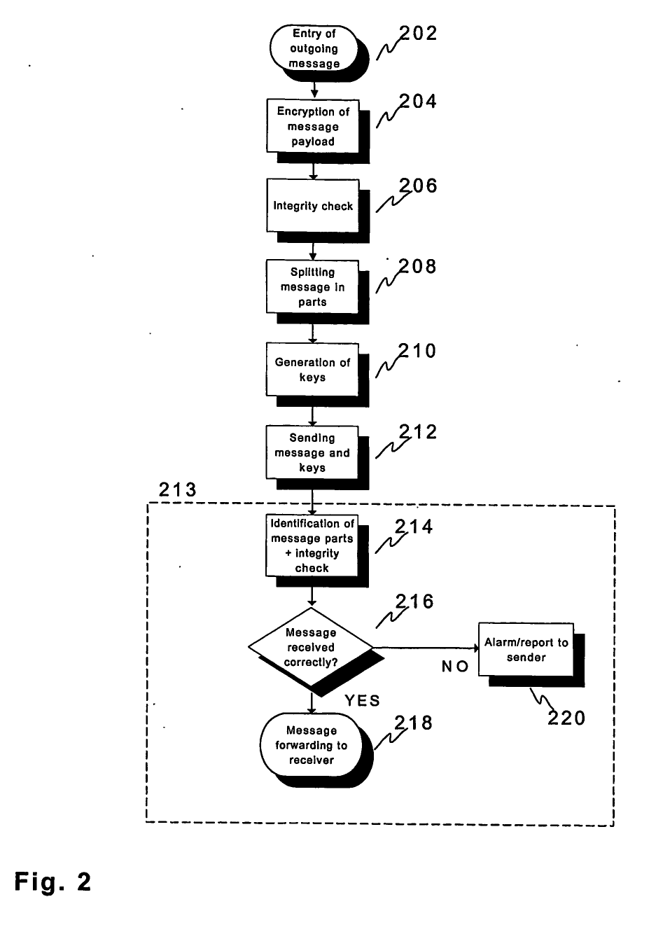

FIG. 2 shows a flow diagram of a basic embodiment of the encryption method suitable for use in a system according to the invention;

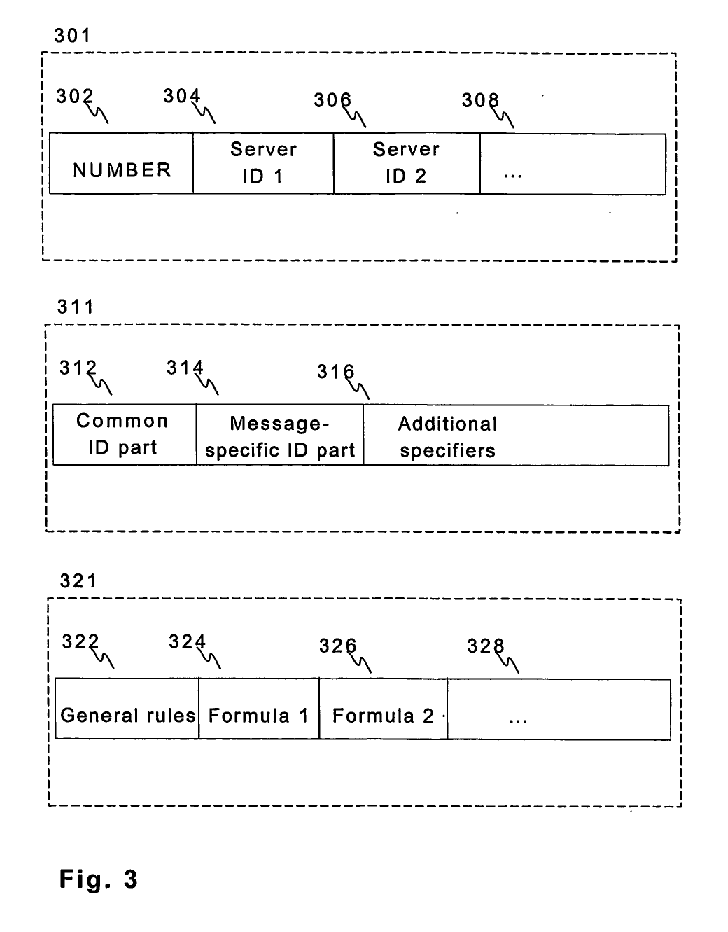

FIG. 3 shows a possible embodiment of an arrangement for handling the server identity, message part identification and combination keys;

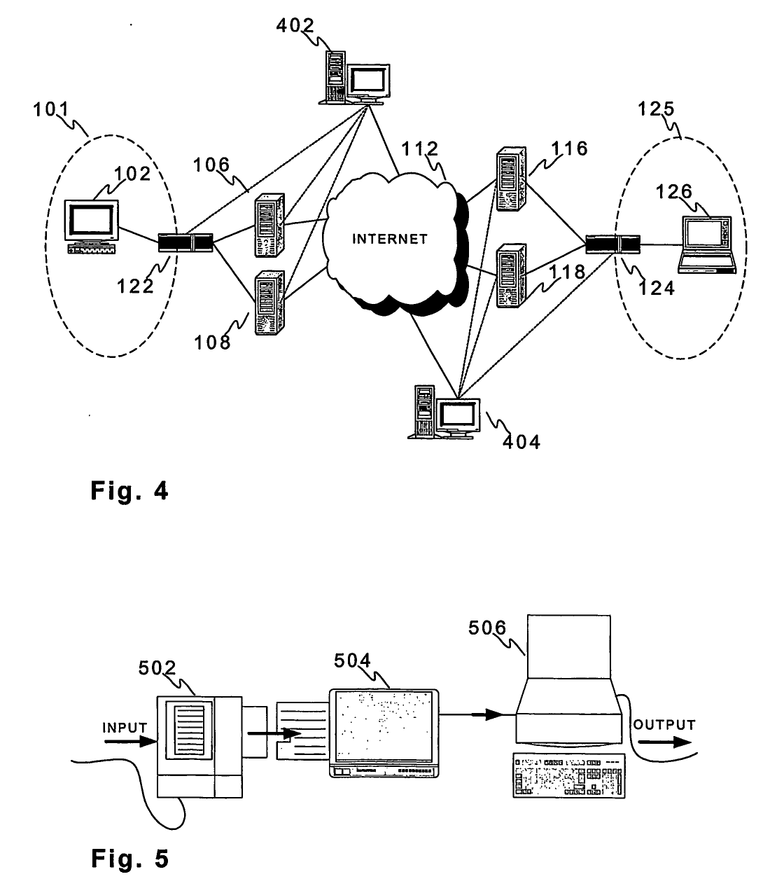

FIG. 4 shows a system according to the invention now complemented with server groups of third parties serving separately the sender and the receiver;

FIG. 5 shows a possible embodiment of an arrangement for data storage for transferring a message from one device to another without having a direct electronic connection therebetween;

FIG. 6 shows an equipment setup according to the invention;

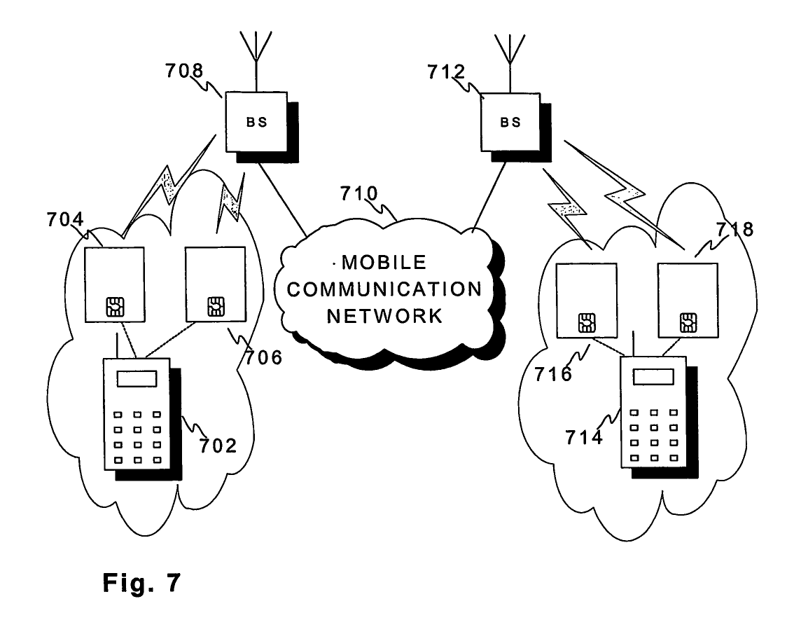

FIG. 7 shows an embodiment of the invention permitting a call to be routed in a format splitted into at least two parts that are transmitted through plural separate connections to a receiver; and

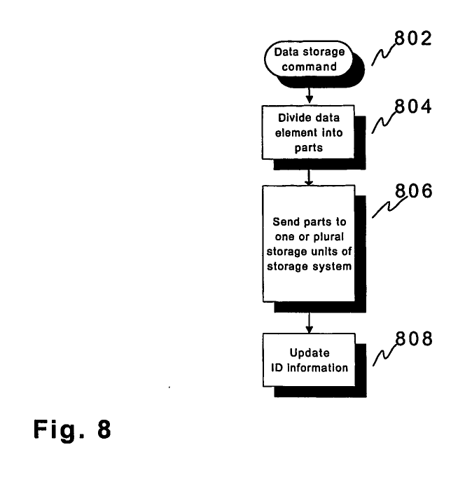

FIG. 8 shows a flow diagram of a data storage sequence according to the invention.

### BASIC ARRANGEMENT OF PREFERRED EMBODIMENTS OF THE INVENTION AND ENCRYPTION OF OUTGOING MESSAGE

Now a first embodiment of the invention is described operating in a TCP/IP (Transmission Control Protocol/Internet Protocol) packet-switched network environment, whose specific features are discussed below to make it easier to understand the basic concept of the invention. It must be noted, however, that the invention may as well be implemented in other environments such as circuit-switched networks, for instance.

In the Internet, the principal task of the IP (Internet Protocol) network layer is to route an IP-addressed data packet to the addressed receiver through plural different sub-networks. As compared with the seven layers of the original OSI (Open System Interconnection) network architecture, the TCP/IP protocol family comprises only four layers: the physical/network access layers, an IP layer representing the network layer, a transport layer and, highest in the hierarchy, the application layer highest. The lowermost layer pair formed by the physical/network access layer provides an interface between the physical architecture of the network and the IP layer thereabove, whereby the connectionless character of the IP protocol allows data packets to be transported in principle via any route to their destinations. The transport layer is responsible for flexible end-to-end communication, e.g., between different applications thus offering different levels of security depending on the protocol used for data transmission. For individual applications, the application layer provides access to the network. In regard to message transmission in TCP/IP networks, in the databases of DNS (Domain Name Service) servers are generally stored dedicated MX (Mail eXchanger) records that link subscribers' network addresses individually to given mail servers, whereto all mail directed to any of those addresses can be switched correctly. Mail servers, such as public SMTP (Simple Mail Transfer Protocol) and POP (Post Office Protocol) servers, are configured to function at maximally high availability level and, moreover, several mail servers may operate at different priorities also within a single network domain thus assuring lossless buffering of messages even if the receiver cannot be found immediately. On the other hand, also routers for instance can be provided with NAT (Network Address Translation) functions that allow, e.g., the computers of a company's local area network to be assigned to a different address space (even of a different character) as compared with that of company's wide-area net.

In an Ethernet-type local-area network, computers may be connected to each other via a common hub. Other possible local-area networks are, e.g., a Token Ring and an FDDI (Fiber-Distributed Data Interface) network. Cabling in a local-area network can be made using, e.g., twisted-pair or coaxial cables. On the other hand, even wireless network configurations such as a WLAN (Wireless LAN) can be employed for connecting, e.g., portable computers, mobile phones or PDA-type terminals to a global network. A hub with multiple ports for connecting computers thereto by default is configured to send data received at one port to all other ports. Inasmuch as the hub is based on a logic-controlled bus, the network topology thus established is only virtually star-shaped in which devices connected to the bus can detect, if so configured, also messages sent by any other device. In Ethernet-type networks data transmission is based on contending for bandwidth using a mechanism known as CSMA/CD (Carrier-Sense Multiple Access/Collision Detect), wherein a computer first listens the network traffic for a free slot and, only if finding one, initiates data send in framed packets. Inasmuch as several computers may start to send simultaneously, the sending station must also listen to the bus for a possible collision in data transmission. When detecting collisions, the sending station halts data transmission for a random interval prior to re-initiating data transmission.

In an Ethernet-type local area network, data transmission from a computer of the like device to another is controlled by device addresses known as MAC (Medium Access Control) addresses, while data flow to an external network is tagged with IP addresses. Hence, each device connected to the network has an individual MAC and IP address. With the help of the ARP (Address Resolution Protocol), the MAC address of the physical layer mapping to an IP address can be resolved in a local area network. An address request is sent to the network without being directed to a given receiver, but the routers will not pass the request out from the local area network. A device identifying the requested IP address responds directly to the requesting device. After learning the requested mapping between the IP/MAC addresses, the requesting device writes the information on its ARP table thus becoming able to later send a data frame directly to the receiver without performing any further requests. To send data out from the local area network, the data must first be transferred to a router that communicates data transmission to the external world. If the sender itself detects the data transmission to be directed out from the local area network, it may steer the communications directly to a router with an LAN address known by the sender. In other cases, the device broadcasts an ARP message requesting the packet receiver's LAN address that maps with the receiver's IP address. The router identifies the receiver of the packet to be situated outside the local area network and, therefore, responds to the request using the router's LAN address. Subsequently, the sender transmits the message to the router. Respectively, it is possible to use an RARP (Reverse Address Resolution Protocol) protocol to resolve the IP address simply from the MAC address. Routing of messages in the environment outside the local area network, e.g., within a domain, is generally based on the use of an internal routing protocol such as RIP (Routing Information Protocol) and OSPF (Open Shortest Path First). Communications between autonomic domains, e.g., between the network operators of different countries or companies, uses so-called external routing protocols, such as BGP (Border Gateway Protocol), because herein routing is not based on efficiency criteria alone, but rather, other factors must be taken into account such as those associated with political, economical or safety aspects that may constrain the number of available signal paths. Such limitations and routing rules must generally be stored manually in the router control programs. Further information on communications networks, particularly at the systems level, can be found, e.g., in reference publication [1].

Referring to FIG. 1, therein is outlined the basic configuration of an embodiment of the invention, wherein a sender's system 101, operating a local-area network such as the above-mentioned Ethernet network, comprises a sending-end terminal 102, such as a PC or an advanced mobile phone connected to the Internet or the like global communications network 112 via a mail server 122 and concealed servers 104, 106, 108 and 110 connected to the network. As a result, the mail server and/or the concealed servers may also be inferred to possess some of the features included in the sender's system 101 and the router connecting the same to the Internet 112. The mail server 122 controls the encryption method according to the invention, whereby the concealed servers to be employed at a given instant are selected from the group of servers 104-110, e.g., allocated on a per message basis or timed by a schedule. The mail server 122 may further control the functions of the concealed servers 104-110 by way of complementing the normal data transmission with additional information, such as extra headers in the beginning of the message or by using entirely purpose-tailored control messages. The terminal device 102 can also be connected directly to concealed servers 104-110 without an intermediate medium such as the mail server 122 with the provision that terminal device 102 inherently contains sufficient processing power to implement the encryption method. On the other hand, this may as well be interpreted so that terminal device 102 inherently contains a mail server at least for handling its own data traffic needs.

In the receiving direction of the message transmission chain, the messages or their parts are received by the group of the concealed servers 114, 116, 118, 120, whereupon they are passed via a mail server 124 to a receiver 126 at the receiver's system 125, wherein the mail server 124 and the receiver's terminal device 126 may respectively be integrated with each other in a functionally cooperative fashion. The sending end can direct outgoing messages in a self-contained fashion to selected ones of the receiving end servers 114-120 with the provision that the sending end knows at least some of the identities of the servers 114-120. Alternatively, before the transmission of the data payload is initiated, the receiver 126 may be programmed to indicate to the sending end those servers of the receiving end that are to be used in the transmission of a given message, whereby a separate transmission procedure of server information for instance may be employed. Still alternatively, if the receiver 126 does not utilize a system of multiple concealed servers, even a single server such as mail server 124 can receive all the messages or, respectively, parts thereof to be used in the reconstruction of the messages, which are directed to the local area network 125, whereupon the messages or parts thereof are forwarded to receiver 126.

Still further alternatively, a plurality of concealed sending-end servers 104-110 can be functionally aliased even by a single server that is programmed to change its identity such as its network address identified by a dynamic IP address, for instance, between the transmission sessions of the different parts of the message. This approach, however, falls behind a system of multiple parallel-operating servers as to its theoretical maximum data rate because the parts of a message must be sent sequentially in time. Advantageously, the sender may further have plural identities of the receiver stored in the sending-end system 101, whereby the parts of a message can be programmed to be send via at least two different user identities.

Technically, the receiving end may respectively comprise only one server 114-120, whereby after the reception of one part of the message, the server 114-120 immediately changes it dynamic address and reports the change to the sending-end server (or other device), whereby one and the same server 114-120 can receive all the parts of the message sequentially via different addresses. Still further, there is no obstacle for having the server 114-120 operating simultaneously under multiple addresses, that is using an address pool, whose identities the server can use as identifiers in the reception of a message or its parts. Obviously the same approach may be contemplated to be used in regard to user IDs.

Still further, it is feasible to have the server 104-110, 114-120, 122, 124 unresponsive to any valid address when the server is in a “sleep” mode. However, this arrangement requires that awakening the server (and setting it responsive to a first address) can be technically implemented in some nonstandard fashion.

In lieu of a server, the use of some other type of network device may be considered applicable. The same contemplation may respectively be applied to, e.g., user IDs (concealed user ID), whereby the senders/receivers of the message parts are virtual users which forward the message to the receiving-end actual user(s) and/or respectively take up the message from the sending-end actual user(s).

Servers 104-110, 114-120, 122, 124 may operate unidirectionally or bidirectionally. Unidirectional operation can improve the data security of a system inasmuch as then the system becomes inaccessible via a sending-end server 104-110, 122 and, conversely, communications from a receiving-end server 114-120, 124 to the global network is inhibited. In a general case, a server with a concealed but not dynamically changing address is advantageously configured to operate in unidirectional mode (thereby transferring messages from a given first direction to a given second direction only) in order to conceal its address or, conversely, make it unnecessary to reveal its address.

Operating in parallel therewith, the concealed servers 104-110 may also be complemented with a so-called integrity check node, e.g., a dedicated integrity check server, connected to receive either direct copies of message parts transmitted from the sender's system 101 or, alternatively and/or additionally, message parts received at receiving-end servers 104-110 thus permitting verification of message integrity. Advantageously, the connection between the integrity check node and the system supporting the concealed servers and/or the sender's system is operated over a fixed high-security path. The message integrity check node may operate, e.g., by connecting the message parts with each other utilizing the key information and then comparing the message compiled from the message parts received directly from the sender's system 101 with the message reconstructed from the message parts received via the concealed servers 104-110, whereby if differences are found, inferring that at least one of the message parts is corrupted by an unknown object such as a virus, for instance, whereby message transmission can be halted and a possible virus alarm can be sent to the concealed servers 104-110 and/or the sender's system 101. Alternatively, and, particularly if the integrity check node receives the message parts only from the sender's system 101 or the concealed servers 104-110, the reconstructed message can be compared only, e.g., with the structural supplementary conditions defined in the key information in order to detect the infiltrated and possibly adversary data prior to forwarding the message. A similar arrangement is also possible to implement in parallel with the concealed servers 114-120 of the receiving end in order to prevent automatic forwarding a contaminated message to the receiver's system 125.

As noted earlier, a connectionless “best effort” IP protocol is used in the Internet for routing data packets when the IP address header of the data packet contains the IDs of both the sender and the receiver. While the IP protocol facilitates the transmission of data packets, also in splitted format when necessary, through the network from sender to the receiver, it does not automatically monitor or secure successful transmission, e.g., in the conjunction with transmission error situations. The IP frames are transmitted above the underlying transmission layers (physical/network access layers) that, in addition to conventional local-area network techniques such as the Ethernet, may include, e.g., SDH (Synchronous Digital Hierarchy), Packet-over-Sonet, Gigabit Ethernet and ATM (Asynchronous Transfer Mode). Obviously, the slower Ethernet techniques are not employed as the backbone of data transmission inasmuch as the enormous amounts of data would instantly consume the relative meager data rate capacity of the Ethernet. Respective protocols employed in the transport layer on top of IP are, among others, TCP and UDP (User Datagram Protocol), of which TCP is a reliable connection-oriented protocol serving to establish a connection between a sender and a receiver prior to the transmission of data payload. To assure reliable transmission, TCP additionally utilizes handshaking, wherein reception of data packets is acknowledged by the receiver. At the end of data transmission, the connection is terminated in a separate phase. TCP also takes care of data retransmission and control of data flow over the connection if so needed. UDP is a light connectionless protocol that cannot by itself establish or control a connection. However, it can complement the outgoing data with a port number in the same fashion as TCP, thus making it possible to direct a correct target application to the receiver. The physical/network access layer may additionally utilize error-correcting and flow-controlling protocols such as LLC (Logical Link Control), wherein the LLC packets are incorporated in the Ethernet packet data. Alternative LLC protocols are the so-called non-acknowledged connectionless protocol, acknowledged connectionless protocol and acknowledged connection-oriented protocol.

When using unidirectional communication links or dynamically changing network addresses, such as IP addresses, in the above-described fashion, also the effect of the other data transfer layers must be taken into account as to the general quality of service and data security of the network. If, e.g., the change of the IP address is made on top of heavy-traffic backbone network, wherein the address-changing node element has connections to plural different direction, mere monitoring of traffic at the trunk network level cannot readily re-identifY a party that has changed its address even if the backbone network addresses (of the physical/network address layer) are kept unchanged. In contrast, the situation varies case-by-case in a small network, wherein the traffic is almost invariably focused to occur between some network elements only. It is also obvious that the network protocols used must also be compatible with unidirectional communications protocols if the data encryption system is to employ one. For instance, the inherently versatile TCP protocol used at the transport layer level cannot function without retransmission of packets unless the receiver sends acknowledgement messages at regular intervals. In the case that the return channel is omitted due to a hacker risk, the system is preferably implemented using, e.g., the UDP protocol that does not need acknowledgement of received data packets but neither cannot verify or enhance the integrity of transmitted data.

An embodiment of the present data encryption method is elucidated in the flow diagram of FIG. 2. In phase 202 the sending end, which may be a message-sending terminal or mail server for instance, receives the task to forward a message whereby the encryption algorithm process is actually initiated. In phase 204 the message data payload is encrypted using some encryption algorithm known in the art. Subsequently, the message integrity is verified in phase 206 in a similar fashion using, e.g., MD5 (Message Digest) or SHA-1 (Secure Hash Algorithm) algorithm. Message integrity check data can be sent separately as a parallel message or along with the message payload. In phase 208 the message is splitted into two or more parts. In phase 210 occurs the generation of message part identification/combination and/or server identity keys for the message, whereby also the keys may be encrypted if so desired.

The splitted parts of the message payload and the message part identification/combination and/or server identity keys are sent to the sender's concealed servers advantageously using a protected (fixed) connection and/or a high-security connection, whereupon the concealed servers send the message parts and all the above-mentioned keys to the receiver's public or, if possible, concealed server(s) in phase 212. The encryption phases at the receiving-end are discussed in more detail later in the text. Data thus transmitted passes via the global network servers and receiver's possibly concealed servers to the receiver's mail server or directly to his terminal, wherein the message parts are identified, integrities of the message parts separately and the message as a whole are checked, the message parts are combined with each other, message encryption is removed and the sender authenticity is verified (with the help of a certificate) in the receiver's system. Dashed line 213 in the diagram separates the phases of reception from those of the sending end. The integrity of the message parts can be checked already in the concealed server (possibly with blocking of message forwarding) and, advantageously, at least prior to allowing the message parts to “see” each other. A second integrity check may obviously be carried out after the message parts have been combined with each other. If the message has been received successfully and also other checks have been passed successfully without any defects 216, the message is forwarded to the receiver in phase 218. This procedure may include, e.g., forwarding the message that was checked and combined in phase 214 to the receiver's terminal or, in the case that such check/combination phases 214 are performed in the receiver's terminal internally, informing the user about the arrival of a new message by means of an audible or visual signal, for instance. In the opposite situation of a complication, an alarm 220 is issued in the receiver's system, a retransmission request is sent to the sender and the problem 220 detected in the procedure is reported to the message sender and/or receiver.

In FIG. 3 is shown a feasible implementation of server identification, message ID and message combination keys. The server identity key 301 contains information 302 on the number of servers forwarding the message parts (or, if a server operates under plural identifiers, on the number of identifiers) as well as the ID data 304, 306, 308 of such servers comprising the IP addresses of the servers, for instance. The length of the server D keys may be varied 308 as necessary depending on the number 302 of required keys. The ID key 311 contains a common ID part 312 for all splitted message parts sent from servers defined in the common server identity key 301 thus allowing the group of message parts to be separated from “normal” data traffic possibly also outbound from the same server(s). The D) key 311 may also be user-specific in the case that plural users employ the same encryption arrangement in the sender's and/or receiver's system. An alternative is to have the messages directed, e.g., to a company's internal mailbox common to plural users in the case that user-specific sorting of messages is not absolutely necessary.

The message-specific ID part 314 contains a specification for controlled combination of individual message parts to prevent erroneous combination of such message parts that are possibly received substantially simultaneously from the same servers but yet belong to different messages. Among other definitions, the specification may contain a mathematical formulation by means of which, e.g., using at least a portion of a message part as the input variable, the identifier can be computed into a form permitting comparison with identifiers computed from the other message parts. Having matching identifiers, the message parts are subsequently combined with each other with the help of a message part combination key 321 into the complete message. Additional specifiers 316 may define the expiry time of the key or information on the minimum number of message parts that must be received from servers defined in the server identity key before complete or at least partial desplitting of a message with the help of the combination key 321 may be attempted. The combination key 321 contains a field 322 defining general rules or parameters that detail, e.g., the content of fields 324, 326, 328 possibly by means of common constants and like factors. Formula 1 in field 324, Formula 2 in field 326 and the successive formula fields 328 contain mathematical formulation on the proper technique of combining message parts received from different servers (the order of combination corresponding to the order of identifier fields in the server identity key) into a complete message. Obviously, as a person skilled in the art can perform the implementation of keys 301, 311 and 321 (with a possible integration of their functional similarities and other features) in a variety of different way depending on, e.g., the network configuration and other constraints, the above description must be considered broadly as an exemplary embodiment not limiting the scope and spirit of the innovation.

When desired, phases 204, 206 and 208 of FIG. 2 may also be carried out in inverse order. Herein, the message is first splitted into parts that are encrypted and checked for integrity. Then, the integrity check data of a given message part can be sent either separately or in conjunction with the same given message part or entirely/partially in conjunction with another part or parts of the same message. Furthermore, the integrity check data may also be cross-transmitted between the message parts or as multiple data parts in conjunction with the transmission of the splitted message parts.

The sender identification of the message parts can be implemented using conventional identification techniques (cf. description of term “server identification key” and FIG. 3B with its description). Moreover, having an integral message formed from the parts of the message using the keys extracted from the message parts is a guarantee that all the message parts are received from the same sender with the different parts of the message being authenticated using conventional techniques.

Encryption of Message Reception

The system according to the invention for message reception described below offers, among others, the following approaches capable of operating in parallel with the basic arrangement, that is, a single receiving-end node such as a mail server 124:

A) Sending a Message to Receiver's Concealed Servers

In this case the level of encryption in reception depends on the type of communications and the level of trustedness of the parties known (or unknown) to each other. The receiver's concealed servers 114-120 are alternatively either
only used by and known to the respective sender;
used by and known to a limited group of senders; or
used by anybody and thus also by uncertified and untrusted senders (that may be known or unknown a prion).

In the two first alternatives, possibility of keeping the receiver's servers 114-120 concealed is dictated by many factors, some of them also being unrelated to communications technology such as when and how secret information is handed over and stored, etc.

The parties may agree in beforehand (outside the network, e.g., when signing a service contract) on the transmission of concealed messages so that the server identity keys as well as the message part identification and/or combination keys have been submitted to the sender and/or receiver by other means (not involving any electrical transmission of the keys). Then the last alternative becomes applicable in certain parts.

In the last case having the receiver's concealed servers 114-120 known to any sender, the present method may be carried out in the following fashion:

I) the receiver has plural public servers (addresses), of which one or more are selected controlledly or randomly for a given session. Then, encryption is based in regard to the receiver's servers on receiving the message in parts via different servers (whereby the message parts can be received via some or all of the receiver's servers), thus making the degree of encryption to be ultimately dictated by the overall number of the receiver's public servers and the number of servers selected to operate during the transmission session. While the data rate is rarely under the control of the receiver, the overall amount of data traffic directed to the receiver in turn affects the ease at which critical data can be detected among other traffic and, thus, the level of security. Herein, the receiver's (concealed) servers are selected controlledly or randomly at either the sender's or receiver's system;

or

II) server data (addresses) are submitted to the knowledge of the sender in conjunction with the message transmission prior to commencing sending the actual message data (in the form of its parts). Sender requests the receiver to submit the addresses 114-120 of the receiver's concealed servers for the ongoing session either
by sending the request from a plurality of his concealed servers 104-110 to a public server of the receiver (operating, e.g., in parallel with the receiver's concealed servers), whereby each one of the sender's (concealed) servers 104-110 requests in the group of the receiver's concealed servers 114-120 at least one address, whereto the sender's requesting server or some other one of the sender's servers then sends (one) part of the message. Advantageously, such other one of the sender's servers 104-110 is not any one of the servers (or server addresses) participating in the server's request operation, because then an outsider party could gain better understanding of the system configuration being employed and improve the knowledge of the outsider party on the more interesting servers; or

by sending a request from plural ones of the sender's concealed servers 104-110 to a public server of the receiver, whereby each one of the sender's (concealed) servers requests to receive a separate transmission of the specific message part containing information on the receiver's concealed server addresses (related to the ongoing session) (or alternatively, the sender launches a message encrypted in accordance with the invention to send the entire message). This phase involves sending the server identity data in the fashion described earlier in the text, whereby the receiver of the server identity data (that is, the sender of the original message) generates the requested message after performing the combination of the message parts. Subsequently, the sender launches the actual data message from either the servers used to send the request or other servers.

The receiver may also send his server identity data directly from his public server, whereby an outsider can gain access to the individual receiving-end server addresses or parts of the server identity message or even to all of the message parts. If the receiver does not send these messages to the sender's public servers but instead, to the sender's concealed servers 104-110, an outsider can also easier identify the sender's concealed servers 104-110. Then, the security of the actual message at large is dependent on the amount of data traffic between the sender and the receiver, as well as the number of servers operating at either end. On the other hand, the sender can submit the identity data of his concealed servers 104-110 available for the transmission of the actual message to the receiver and/or receivers' concealed server 114-120 only after having received information on the identity of the receiver's concealed servers 114-120 by way of using his so far unused concealed/public servers for sending the request message of server identity, or
by sending a request in accordance with the first alternative (item I, wherein the receiver operates using plural servers), whereupon the transmission of server identity data takes place in the above-described fashion.

Irrespective of which one of the above-described techniques is selected, the receiver's concealed servers 114-120 will send the message (or parts thereof) advantageously using a closed (fixed or high-security) link to the receiver's system 125, either to an intermediate message-compiling device such as mail server 124 or directly to receiver 126. Hereby, the message parts are identified, the integrity of the message parts and entire message are verified, the message parts are connected with each other, and the encrypted message is decrypted, whereby the sender identity is verified with the help of an authenticity certificate.

B) Message Transmission Via a Third Party Offering Enhanced Trust

In FIG. 4 is shown a modification of the embodiment of the invention illustrated in FIG. 2, now with trust-enhancing third parties complementing separately the operation of sender 402 and receiver 404. For greater clarity, the diagram has been streamlined by limiting the number of servers 106, 108, 116 ja 118 to four. In practice, the third party provides for both the sender and the receiver one or more message server(s). Alternatively, the third party may be common to the sender 102 and the receiver 126, whereby respectively also servers 402 and 404 shown in the diagram can be merged into one server. The sender's system 101 can be linked to the system of the sending-end third party 402 over either a direct high-security connection, a high-security connection via the sender's concealed servers 106, 108 or, in a conventional fashion, over a global communications network 112 using standardized protocols and/or encryption according to the invention. The receiving-end third party 404 can be connected to the receiver's system 125 in a similar fashion, whereby the high-security connections possibly implemented in a fixed fashion are encircled within dashed lines. In principle, also the different third parties can be linked to each other over fixed high-security connections.

In the case that the receiver alone has assigned a third party 404, communications may be carried out as follows:

1. Message parts and server identity as well as message part identification/combination keys are sent to the third party 404, in practice, to the server(s) of the third party.

Herein, sender 102 need not necessarily know that the message is first routed to the third party 404 if receiver 126 has only indicated the server(s) to be used for communications without any reference at all to the involvement of a third party. Obviously, it is also possible that sender 102 provides the server identity key and/or the message part identification and/or combination key to receiver 126 via an alternative route (e.g., by submitting outside the communications network a semipermanent or one-time usable key or a list of such keys), whereby the third party 404 is prevented from gathering instantly all the information required for desplitting a message. This kind of approach provides some guarantee against the odds that the trustworthiness or security measures of third party 404 would fall short of absolute. The same caution may also be applied to one or more parts of the message.

If the information required for the identification of the actual receiver is included in every part of the message, the third party 404 can forward the message parts to the receiver without an identification key. Furthermore, the third party 404 does not need know the identification key when all the message parts are sent to such servers (addresses) of a third party that are assigned only for the reception of messages addressed to the specific receiver 126.

The third-party receiving-end servers 404 in this alternative embodiment are:

a. (only) one globally known server; or

b. plural globally known servers, whereto message parts are sent in a more or less random order; or

c. one or more concealed servers (or server addresses) committed for the use of sender 102 alone or also by others. Sender 102 requests the server addresses from the third party 404 preferably in the fashion described earlier in the text.

2. The third party 404 sends the message in parts to receiver 126 addressing the message to the receiver's concealed servers 116, 118. The third party 404 is involved under an assignment mandated by receiver 126. Hereby, receiver 126 has submitted to the third party 404 information on his concealed servers 116, 118, whereto the third party 404 shall send the message parts. If an entirely secure fixed connection has been established between the third party 404 and the receiver 126, the third party 404 can send the message also directly to the receiver's system 125 instead of routing the message via the receiver's concealed servers 116, 118.

3. Concealed servers 116, 118 of receiver 126 send the message (or parts thereof) via a protected (fixed or high-security) connection to the receiver's system 125.

4. The message parts are identified, the integrities of the message parts and the message itself are checked, the message parts are combined with each other, the encryption is removed and the authenticity of sender 102 is secured (with the help of a certificate) in the receiver's system 125 by a process running, e.g., on mail server 124 or receiver's terminal device 126.

If both sender 102 and receiver 126 have indicated the involvement of a third party 402, 404, the following procedure takes place:

1. Sender 102 transmits the message (or parts thereof) over a protected (fixed or high-security) connection to his assigned third party's system 402, wherefrom the message is routed
directly to receiver 126 in accordance with item 2 described above with the provision that receiver 126 has signed an encryption agreement with the same third party 402 or if the receiver has granted his own third party 404 an authority to submit the identity data of his concealed servers to the first trusted party 402 (third party assigned by the sender), whereby such submission of secret data will take place if so desired over a protected (fixed or high-security) connection; or

over a protected (fixed or high-security) connection to the receiver's assigned third party 404 that forwards the message to receiver 126 via his concealed servers 116, 118.

2. Third party 404 sends the message splitted in parts to receiver 126 via his concealed servers 116, 118.

3. Receiver's concealed servers 116, 118 forward the message (or parts thereof) over a protected (fixed or high-security) connection to receiver's system 125.

4. Message parts are identified, the integrity of the message parts and entire message are verified, the message parts are connected with each other, the encryption is removed and the authenticity of the sender is secured (with the help of a certificate) in the receiver's system 125.

In the last alternative arrangement, only sender 102 has assigned a third party to whom he sends the message to be forwarded. Subsequently, the third party 402 sends the message to receiver 126 advantageously in the same fashion as the sender would have performed in the absence of the assigned third party.

Keeping the Secrecy of Concealed Server

Generally, the address of the sender's and/or receiver's concealed servers 106, 116 will become known to one of communicating parties or to the third party involved in the message transfer, whereupon resultingly server 106, 116, more specifically by its address, is not concealed anymore at least to the communicating party/parties. The secrecy of server(s) 106, 116 is implemented in the following fashion (with the provision that the server is not exclusively dedicated to the use of one party):
Server 106 is configured to fully conceal its address, which condition can be accomplished in practice only in regard to server 106 sending the message (or a part thereof) and, even here, principally (and maximally) for only one or few messages but never for all of messages sent from the server; or
Server 106, 116 changes its network address after each session or, alternatively, assumes its (temporary) address dynamically for the ongoing session. Advantageously, such a dynamic network address is selected from a larger address space. This approach may be optimal for most cases. During the ongoing session, server 106, 116 submits its new dynamic address to the server (or the like device) communicating therewith.

Before receiver 126 can be assured about the true identity of message sender 102, the receiver must get a so-called authenticity certificate from a third party (such as VeriSign, for instance). The third party may appropriately be depicted, e.g., as parties 402, 404 drawn in FIG. 4. The third party can also submit this kind of authenticity certificate via a concealed server 106, but such a certificate is valid for the receiver only if he has a priori obtained and has been capable of (e.g., by being a member of a trusted user group) reliably obtaining (again a priori) information on the ownership of server 106. Hence, in such cases that are different from those described above, at least one message part and/or the server identity key and/or the message part identification/combination key must be sent via a known server in order to facilitate the reception of a usable certificate via such a server. The amount of information to be sent via a known server is determined on the desired level of security vs. the desired level of authenticity of sender 102. If the servers are operated with dynamic addresses that are changed after each session, the authenticity certificate of concealed servers may also be submitted to the receiver inasmuch as there is no particular risk of revealing the actual ownership of the servers due to the temporary character of the server address(es) (which may be selected, e.g., for a predetermined time of use from a larger address space). As mentioned earlier, the level of protection obtained from the use of temporary addresses is typically determined by the combination effect of several different data transfer layers, whereby for instance allowing a device to actively change its dynamically assigned IP address simultaneously as the lower level MAC address of the device is also dynamically selected from a larger group of addresses, a further reduction in the risk of revealing the ownership of a server can be obtained.

The third party may possess a large number of temporary addresses submitted by the server owner in beforehand or, alternatively, the server owner will submit the realtime-valid address(es) to the third party in mutually-agreed fashion. Sender 102 may then request the valid IP addresses of the concealed servers from the third party or receiver 126.

After the server addresses have been used once (for sending, receiving or during a full session), they are either annulled or set to be revalidated after a random or otherwise controlled fashion in regard to time and connections.

User Privacy Protection

The arrangement of FIGS. 1 and 4 adapted to transmit via concealed servers 104-110 allows a computer user connected over a communications network to retain his privacy during a session in an improved fashion in regard to other parties communicating in the network and, moreover, in regard to the other party/parties of the session also after the session.

Herein the question is not necessarily about encrypting a message but rather also or only about a case in which a user wishes to contact another party (e.g., to download www pages) so that the other party cannot directly contact the user on his own initiative (e.g., by pushing address data) again at a later instant of time.

The user can furthermore specify that inbound communications to a computer and, respectively, outbound communications therefrom shall occur in a predetermined fashion via servers assigned to a given session. Herein, e.g., the user's actual system or a proxy preceding the same is controlled to accept a message only if the system/proxy has received from concealed servers a confirmation that all the servers have received one part of the same message in question defined in an identification key (submitted by the user to the other party or created by the other party itself) and that all the parts of the message are stored in the concealed servers. Now, if an outsider knowing one concealed server by chance or through information gained from earlier communication between the parties attempts to send a message via a server address thus gained, the message will not be forwarded up to the user's system inasmuch as the message (or a part thereof) is being received only from one concealed server and/or the received data does not contain an identification key verified by the system (the message may contain, e.g., an outdated identification key that the user's system has verified sometimes before, maybe only once but not anymore).

In the exemplary embodiment described above an alternative approach is to have the concealed servers 104-110, 114-120 connected to each other in order to assure that the preconditions for forwarding the message parts to the user's actual system are fulfilled—e.g., other ones of concealed servers 114, 118, 120 report the reception of a message part to one concealed server 116 that after collecting sufficient information from all concealed servers 114-120 issues the other servers 114, 118, 120 a permit allowing the forwarding of message parts to the user's system (herein, however, mutual communications between the concealed servers may increase the risk of revealing the entire server group).

A computer connected to a network is typically used for

a) establishing a connection to other computers connected to the network;

b) offering a potential connection to the computer from other users over the network; and(/or)

c) other tasks, e.g., running programs installed on the computer.

Item (b) most generally involves some external party who wishes to send an e-mail message to user 126. To protect the user's system 125 already during the first approach, the user's public network address (e.g., e-mail address) is not actually stored in the user's system 125, but instead in server operating between the user and the network. This public server, which may be arranged to function in “parallel” with, e.g., one of the concealed servers 114-120 shown in FIG. 1, in conjunction with one of the concealed servers 114-120 or in an entirely separate device that may be the third party 404 in the global network 112 whereto the request for a connection has been addressed, informs the user 126 of the inbox message (and its content) by one of the following methods:

1) using the techniques described earlier in the text, sender 102 is informed of the receiver's concealed servers 114-120 whereto the message or parts thereof shall be sent and wherefrom forwarding to the user's system 125 will take place. An alternative arrangement herein for improved level of security is that user (receiver) 126—unless otherwise agreed upon (with the sending or a third party)—forces sender 102 to request the receiver's concealed servers 114-120; or

2) the inbox message (e-mail or the like) is sent as an entity or in parts, whereby message splitting hardly can improve the level of security if the message has been already sent as an entity to a global server, to the user's concealed servers 114-120:
directly, that is, either skipping to send a request to sender 102 for an encrypted message, or due to a report from sender 102 that he is incapable of sending a message encrypted in accordance with the invention to user's concealed servers 114-120; or
in a format permitting a user's concealed server 114-120 to interpret the information about the message or the entire content of the message by scanning or the like reader techniques. Herein the user has the option to define the scope of information to be interpreted.

In FIG. 5 is shown an implementation of the above-mentioned reader technique using a technical layout comprising, e.g., a display or printer device 502 for converting message into a readable format and a scanner 504 connected to computer equipment 506 running an OCR (Optical Character Recognition) software. The message printed on the display or paper media is read with the help of a (video) camera or dedicated scanner 504 back into electronic format and also preferably interpreted back to text format with the help of the OCR software running on the computer equipment 506. The software may also be embedded in the (video) camera or scanner 504.

In practice the embodiment of FIG. 5 can be adapted in an extremely multifaceted fashion to different kinds of connections. According to this exemplary case, a WWW server provider may configure between the server and its network interface a bidirectional setup, wherein it is possible by means of a duplicated combination of a display/printer and camera/scanner to implement without an electronic interface firstly the forwarding of inbound requests sent by users in a visual format toward the server (e.g., indication of a given link and service activation on www page of the same by a mouse-controlled arrow cursor, whereby the location of the mouse pointer on the page is detectable on the original print of the www page and detectable on the same by the camera or scanner from the printout of the page) and, secondly, the forwarding of the information (e.g, a www page) indicated by the requests via the network interface to the users. The pattern recognition software running on the server can be adapted to identify the pattern and location of the mouse pointer on the printed image. Respectively in the outbound direction, the printed image can be sent as such (e.g., in a known image format) or, alternatively, by first dividing the image with the help of pattern recognition into smaller elements such as the background, text fields, links, etc. Also audible commands can be transmitted to the server without using a direct electronic interface if the commands are first converted to acoustic format for transfer between network interface and the server and then back into digital format via a microphone. Thereupon the commands are interpreted by voice recognition software.

User 126 can set the concealed server 114-120 to read the information in the above-described fashion using, e.g., the following criteria:

i) reading information about the message sender, address and/or content (typical information of an e-mail message);

ii) in addition to the previous item, reading the content of a possible insert file;

iii) in addition to the previous items, reading the settings possibly carried by the message (and its insert file) as well as other commands of the software recognized by the instant server and the user's concealed server, particularly as regards to the insert file mentioned in the previous item;

iv) in addition to the items above or in lieu thereof, the message is read in a digital format, whereby the interpretation of the message as to all aspects thereof is carried out in a more comprehensive and error-free fashion. The trade-offs of this step, however, involve a higher risk of virus attacks, for instance.

To verify the interpreted information, the concealed server 114-120 can send the interpretation of the information to a public server (or the public server may respectively scan or otherwise interpret the information as received from the concealed server) for additional verification, whereupon the public server performs the comparison and reports any errors to the concealed server 114-120, that is, offers the concealed server an option to read the report of possibly required message amendments. Message error corrections can be carried out a predetermined number of iteration rounds or as many times as is necessary to provide the concealed server 114-120 with an error-free message.

As a rule, the communications of item (b) relate to the reception of an e-mail message (including its insert file), whereby generally the read-out interpretation of the message in accordance with items (i) and/or (ii) (and/or item (iii)) is sufficient. Herein, the principal task is to interpret the message content (as to item (iii), only in limited fashion), whereby the user need not even reveal the identity of his concealed server to the sender.

Indication of concealed server(s) may, however, be necessary if, e.g., user 126 considers after receiving a message in accordance with items (i), (ii) or (iii) (as to item (iii), only in limited fashion) that it is secure and/or necessary to receive the message in an electronic format from sender 102 directly (possibly via concealed server). In certain cases, the user may also find this approach more secure than the arrangement defined in item (iv).

An alternative embodiment of the above-described use of a scanner is that the message is interpreted only for the information of sender's servers 104-110 and the sender's servers 104-110 are informed, using the techniques described earlier in the text, about the user's concealed servers 114-120, whereto the message (or parts thereof) are requested to be sent.

An implementation based on scanning or other like reader technique carried out in a fashion isolated from the object in question (cf. items (i), (ii), as well as item (iii) in a limited fashion and item (iv) even in a more limited fashion) can also prevent entry of computer viruses to the user's system, whereby this arrangement may thus be considered to represent a novel approach to the prevention of virus attacks. The user's own computer system 125 or his public/concealed server 114-120 may additionally check the message being opened as to its possible virus infection (particularly in conjunction with items (iii) and (iv)). If finding a virus, the user's system 125 will not store the message nor allow server 114-120 to forward the message. Instead, the system can issue a virus alarm to system 125 according to a predetermined procedure.

The functions to be performed herein may be adapted to be user-definable. The user can then give the public server also other conditions for message forwarding (e.g., to eliminate spam mail by conventional techniques).

Utilizing the above-described arrangements, computers connected to a network can be divided into public and private (or combinations thereof) computers, of which the latter ones are accessible and identifiable by other network users only if the owner of the specific computer so desires. The public owners of computers connected to a global network are typically those who for instance wish to be contacted by, e.g., to market their products or to act as information providers in the network. Even those users that fall in class are advisably directed to limit the communications of their public-address computer only to such messages that are of a justified public nature.

Hence, a private computer is set by default in a state to receive from the network nothing else but
messages described in item b) above in the fashion defined by the user; and
messages of the type described in item a) at an instant of time and type of reception defined by the user himself, whereby the user can retain his privacy by choosing the reception of the message to take place in the fashion as described earlier in the text. Advantageously, sending the messages may also be carried out in the above-described fashion that only provides a supplementary contribution to the protection of the user privacy.

In FIG. 6 is outlined the use of a device, typically a computer or an advanced phone set or mobile phone adapted to function as an element of the security-enhancing system according to the invention, either as a sending/receiving party or as a message-relaying server, whereby the system requirements as to equipment specifications basically are substantially quite equivalent. This kind of device comprises a program/data memory 610, e.g., a RAM circuit, and a nonvolatile memory such as a hard disk or a diskette station for the storage of software commands of, e.g., an encryption application 614 and other data 616 such as outgoing/relayed messages, and a processor 610 for performing such software commands and controlling the general functions of the device. In addition to storage in the internal memory circuit or on the hard disk of the device, the software according to the invention can be stored on different portable media such as a CD-ROM disc, memory cards or a diskette. The device transmits data to the external networks via a permanent or wireless connection communicating through a data interface 602 that may be, e.g., an Ethernet card or, in a mobile communicator, a transmitter/receiver unit. The user can control the device via its user interface 612. The user interface 612 comprises a keyboard, a mouse or the like control means and, e.g., voice recognition software. Information shown on the display 604 tells the user the realtime status of the device. The audio interface 608 with the microphone, loudspeaker and amplifier components serves in the telephone application of the present invention to implement the generation of the acoustic signal and conversion thereof into an electronic format.

Telephone Network Application of Invention

In the encryption arrangement according to the second embodiment of the invention, the calling and/or called party has a telephone, either a POTS line or a state-of-the-art mobile phone with two or more connections (˜subscriptions). If one of the parties has only one (conventional) connection, limited level of security is achieved in relation to a party monitoring aforesaid one of the parties. However, the telephone set in this case must contain a message splitting/desplitting function that allows the phone to be used in a call that is encrypted (on one end).

In FIG. 7 is shown an arrangement according to the second embodiment of the invention applied to communications in a mobile phone system supporting a call between two subscriber connections. Inasmuch as an equivalent arrangement may also be implemented in a POTS telephone network, the configuration shown herein must be understood to represent an exemplary embodiment of the invention. In the diagram, mobile terminal 702 depicts the caller's phone, that is, the calling party, and respectively mobile terminal 714 is the receiver's phone, or the called party. Both the caller 702 and the called party 714 have their mobile terminals 702, 714 equipped with public or conventionally concealed subscriber connections 704, 716. Additionally, both the caller 702 and the called party 714 have acquired concealed subscriber connections 706, 718 in their terminals. The terminals 702, 714 are linked via base stations 708, 712 (BS) to a mobile phone network 710 that may further communicate with a public telephone network. The subscriber connections may be assigned to the subscribers in a permanent fashion, e.g., by an SIM (Subscriber Identity Module) card or dynamically via message communications, for instance. Hence, the present arrangement is not limited to any specific connection type or technique.

In the calling phone 702, the signal is split after the A/D conversion into two parts 704, 706. This kind of splitting can be performed by, e.g., parametrizing the voice signal in the coding phase and dividing the parameters in two different groups. In the receiving phone 714 respectively, the different signal parts 716, 718 are combined prior to the D/A conversion. The combination process can be carried out, e.g., in the DSP (Digital Signal Processor) of the phone. Alternatively, the signal can be splitted in its analog format prior to the A/D conversion and then combined back after the D/A conversion. Further alternatively, if the mobile terminals 702, 714 support transmission of packet-switched data (e.g, via GPRS, General Packet Radio System), they may be allocated to have, e.g., a dynamic or switchable IP address in lieu of multiple subscriber connections, whereby the implementation of the present security-enhancing method will in practise be done at a higher level in the transmission hierarchy.

In the present arrangement, the message need be encrypted not at all, if so desired, or only up to a level conventional in the state-of-the-art communications systems. When so desired, the keys can be omitted with the exception of identification key 311, whereby splitting/desplitting of the message parts occurs at all times in a fashion permanently preprogrammed in the mobile phone. The identification key 311 may in its simplest form be such that the message parts identify each other from, e.g., the subscriber connection numbers of the sending end and the time of sending-end transmission (e.g., by requiring an exactly equal time of message part transmissions).

In the following are described four alternative embodiments of the arrangement shown in FIG. 7.

Alternative a:

In this embodiment, the number of subscriber connection 706 is known only to the operator (the trusted security department thereof) of the calling party 702, whereby the calling party 702 does not know the concealed connection 718 of the receiver. When caller 706 initiates a call, the caller's concealed connection 706 always first places a call to his own operator (either to a fixed or a dynamically variable number of the operator) who forwards the call to the called party's mobile terminal 714, a concealed subscriber connection 718 therein, if also the called party 714 operates under a concealed connection known by the operator of the calling party 702 (e.g., when also the called party 714 is a subscriber to the same operator) or by the operator of the called party 714 (which operator is contacted by the operator of calling party 702). In lieu of the operator's trusted security department, it is also possible to pass the calls via a trusted third party.

Alternative b:

This alternative functions in the same fashion as alternative (a) with the exception that the calling party 702 knows the concealed subscriber number 718 of the called party 714. Then, the concealed subscriber number 706 of the calling party 702 can directly contact the concealed subscriber number 718. If the concealed subscriber number 706 of calling party is desired to be concealed from the called party 714, the called party 714 is allowed to see only the general operator number (one of plural fixed numbers and/or a dynamic number) of calling party 702, wherefrom the message transmission takes place to the calling party's concealed subscriber connection 706 under a number not displayed to the called party's concealed subscriber connection 718.

Alternative c:

The subscriber number of concealed connection 706 is known to the called party 714, but neither the calling party 702 nor the operators of the calling party 702 or the called party 714 know the concealed connection 718 of the called party. Herein, the calling party's public connection 704 (that as well could be a concealed connection 706, but it's better to keep the concealed and public connections separate as noted later in the text) calls the called party's public number 716 and requests the called party 714 (particularly his concealed subscriber connection 718) to contact the calling party's concealed connection 706 known to the called party. Subsequently, the concealed connections 706, 718 of the calling party and the called party can communicate with each other. The billing of calls between the concealed connections 706, 718—if charged by the operator supporting the system—may be assumed chargeable from the account of the calling party's public connection 704 (that is, of the actual calling party 702). If the called party's concealed connection 718 is desired to be concealed from the calling party 702, the calling party 702 is allowed to see only the general operator number (one of plural fixed numbers and/or a dynamic number) of called party 714, wherefrom the message transmission takes place to calling party's concealed subscriber connection 718 under a number not displayed to the calling party's concealed subscriber connection 706.

Alternative d:

This alternative functions in the same fashion as alternative (c) with the exception that called party's concealed connection 718 is known to the calling party 702. Then, the concealed connections 706 and 718 may directly communicate with other in a conventional fashion.

In all the alternative embodiments described above, the public connections 704 and 716 communicate with each other by sending a part of the data signal (e.g., half thereof), while the concealed connections 706 and 718 communicate the rest of the signal as described above.

Data Storage Application of Invention

In addition to or in parallel with data encryption, the present invention facilitates distributed storage of data. The present arrangement offers a novel type of data storage secured against data thefts using so-called spyware or other techniques, and against other unauthorized actions. Data protection herein is implemented by way of splitting the data element (any information, data, file, message or the like knowledge to be protected, later called the “data element”) in the above-described fashion into two or more parts, whereupon the parts are sent from the user's terminal device 102, server 122 or mobile phone to the storage units of the storage system that may comprise, e.g., concealed servers 104-110. Also the user's conventional system 101, 102, 122 may be used for storing at least a portion of the data element and/or the necessary keys in toto or partially with the provision that the data element is never stored in unsplit format in one and the same location. The user, however, possessing the data element identification information (such as an identification key) has the power to retrieve the data element later in order to, e.g., use the data or forward the same.

In FIG. 8 is shown a flow diagram of the method for storage of data elements. The system receives either from the user via a user interface or, alternatively, from an automated application a command to store 802 a data element in accordance with the invention. In this phase the data element may also be encrypted or hash-coded using conventional encryption techniques or, simply, by rearranging its contents. The data element is splitted in parts 804 and sent to at least one data storage unit 806 of a data storage system. Finally, the system stores and updates the identification information 808 of the splitted data element for later retrieval and combination of its parts.

The user can store the identification information of a given data element in his system or other media, e.g., advantageously in a database isolated from global communications networks or in a separate system (later in the text an “identification database”), wherefrom the identification information can be retrieved and sent in different ways. The storage of identification information can be implemented advantageously, e.g., as follows: a directory is created for the data elements and the files thereof are named in the same fashion as in a conventional Windows-based system. However, the file thus stored contains only identification information of a given data element (e.g, an identification key) and, if necessary, a tool (e.g., a server key) for finding the actual data element, whereby this information is sent to the user's conventional computer system or is retrieved by the user's system from the identification database using the above-described data retrieval techniques, for instance. Based on this information, the user's conventional system searches the parts of a data element and the necessary keys (e.g., combination key of data element parts) from the concealed servers 104-110. The identification information may also be sent (using a protected or high-security connection) directly to the concealed servers 104-110 that simultaneously are requested to send the data element (that is, its splitted parts and keys) to the user's conventional system.

If permitted by the read techniques and file type/size used, the identification database may also be used to store the file and/or its keys, either entirely or in part, whereby these portions of the data thus stored need not be sent (even in parts) to the concealed servers at all, but instead, the requested information can be retrieved directly from the database to the user's conventional system.

The concealed servers must provide a sufficient storage capacity with such specifications that the user's conventional computer system can retrieve information therefrom as requested by the user or they can send information to the user's system as requested by the user or under a command transmitted directly from the identification database. If a data element is desired to be sent outside the user's system, the concealed servers may advantageously carry out the outbound communications directly using the encryption method described in this invention without first sending the data to the user's conventional computer system.

The concealed servers are allocated to handle data storage and transmission for plural individual users. This service can be provided by, e.g., an operator or other third party offering data storage/delivery services.

The data element may be stored in protected form so that it never visits the user's conventional computer system (at least not due to this function). To accomplish this feature, the data element sent to the user (in splitted form) stays in the user's (receiver's) concealed servers 114-120 (or stored in devices of other identities) that only report in the forwarding direction the arrival of the data element and the preset supplementary information of the data element (e.g., sender identification). This arrangement may also be applied in such a fashion that a given portion of the data element (e.g., a cover page) is submitted to the user's (receiver's) system 124-126 and the portion thereof to be encrypted remains (at least temporarily) stored in distributed parts on the concealed servers 114-120. The data portion to be encrypted may later be sent to the user's conventional computer system when requested by the user.

The user may also send the data element or the portion thereof to be encrypted forward without storing the information at all in his conventional computer system. This is accomplished by submitting a send command and receiver identification information to the user's concealed servers that then send the message (or parts thereof) advantageously using the techniques described earlier in the text.

The identification information of an inbound data element can be stored in the identification database either using the above-described read techniques or otherwise. According to a preferred embodiment of the invention, herein is used a computer connected to a public communications network, whereby the part of the computer that interfaces the network receives the data element identification information, and subsequently the information is transferred to another part of the computer and its hard disc (or the like media) not communicating with the global network, both parts advantageously using the same keyboard and display.

Also the storage and controlled forwarding of the received information may be carried out by a network operator or other third party.

While not specifically mentioned above, all said about the processing of data elements is also applicable to the data part combination and other keys.

In this embodiment of the invention, the use of external servers 104-110, 114-120 is not necessary if the user's system such as his computer equipment, e.g., terminal 102 in FIG. 1 and/or server 122 connected thereto, inherently includes plural storage media such as a hard disc, disc drive, writable CD station or a memory card/circuit thus facilitating the splitted data storage technique described above. Herein, if the storage media are physically separated from each other, e.g., in locked and solid structures such as tamper-proof cabinets, a direct risk and damage due to partial media thefts can be minimized and, furthermore, a person intruding the system via a communications network cannot readily read the critical data inasmuch all the information is logically distributed and splitted in parts in a nontraceable fashion.

Moreover, with the help of multiple separate processors and/or memories, also the actual processing of data can be distributed by combining the data element parts only, e.g., at the output device such as display (or printer) or, in practice, in the driver circuit of the device prior to outputting the data onto the physical screen. Herein, the working memory of the system may be understood to operate in a distributed fashion. The application of the present method in different environments is dependent on the actual content of the data element and the equipment and/or software used in the system inasmuch as the realtime control of distributed data may need, again depending on the case, additional computing and data transmission capacity from the equipment in order to prevent additional delay in printing, for instance.

An exemplary embodiment for practical purposes of utilizing a distributed working memory can be elucidated by making reference to, e.g., a modern text processing program. Typically, a document to be edited in a text processing program contains text lines, text paragraphs, diagrams, tables and the like partial entities that can be extracted from the document (either naturally like a text paragraph or by processing means applied to character sequences of predetermined length and the like). Now the invention allows the storage of, e.g., the pictorial content of a document separately from the other text or, e.g., extraction of sequential text lines/paragraphs alternatingly into separate memories, whereby the document splitting resolution (or coarseness) is set either in a permanently preprogrammed fashion or to be variable. The desplitting of the document for display advantageously occurs not earlier than in the display device driver. The realtime processing (editing, etc.) of the document may be handled by a first processor operating in conjunction with a one working memory that under the control of commands entered by the user stores and/or processes the information in its own working memory and then transfers the commands and content-related data of this first working memory to a processor operating in conjunction with a second working memory. Herein, the first processor maintains the information related to the desplitting of document while it simultaneously also controls the second processor and, optionally, the display driver to print the information in correct format (and displayable at a desired instant) on a display screen. Both ones of the working memories and processors are advantageously connected via separate buses to the display driver. Alternatively, a single common processor can control directly the operation of both working memories if, e.g., the display driver contains all the required logic circuitry and data interfaces for fetching the displayable information directly from separate memories under the control of the common processor, whereby security risks are minimized inasmuch as the partial information need not be combined in the processor prior to the final printout/display.

The system, method and device layout described herein for data encryption and/or storage offers a novel kind of approach to improved security and storage of information in communications. Conventionally, messages are encrypted as entities prior to their forwarding, whereby even an encrypted message can be captured in whole and later decrypted by “brute force” techniques later simply through listening to a given data path. The additional security rendered by the present invention is based on the concept that an eavesdropper cannot now as readily get hold of all the parts of a message nor combine the same into a readable format if the message parts are sent via different parties and are passed to the receiver via alternative, e.g., randomly configured routes. The invention can also utilize dynamically changing network addresses in order to further complicate eavesdropping, whereby simple monitoring of a given node in high-traffic packet-switched networks becomes still more complicated for a hacker to detect which messages are associated with each inasmuch the sender identities change, e.g., in a timed or per session fashion. Obviously, the above-described embodiments of the invention represent nonlimiting exemplary embodiment, whereby the implementations of the different modifications of the invention may be varied within the scope and inventive spirit of the invention disclosed in the appended claims. For instance, the structure and communications protocols of the networks may differ from those described above and, respectively, the equipment used for message encryption can be different from those described in the exemplary embodiments with the provision that they contain certain components such as a processor, a memory with software indispensable to implement the basic concept of the present invention. Additionally, the invention can be flexibly integrated with conventional encryption methods in order to further improve the level of protection.

### REFERENCES

Peterson L. L. & Davie B. S., Computer Networks: A Systems Approach, Morgan Kaufmann, ISBN 1-55860-5142 1999

1. A method for encrypting data in an arrangement where data is transferred from a sender to a receiver over a communications network, characterized in that the method comprises the steps of
splitting the data into at least two parts in a fashion substantially unrelated to the data content, the parts being individually recognizable and connectable with each other by means of key information (208), and
sending the parts independently via different identities (212) available in the arrangement, the identities belonging substantially to at least one of the types: server, subscription, address, user identifier.

2. The method of claim 1, characterized in that the method additionally comprises a phase including at least one of the steps: encrypting (204) the data, checking (206) the integrity of the data.

3. The method of claim 1, characterized in that said key information is submitted to the data receiver or a third party which is assigned by the data sender or receiver.

4. The method of claim 1, characterized in that said key information is programmed in a device owned by the receiver or the third party.

5. The method of claim 1, characterized in that said key information includes at least one of the following key categories: server identity key for defining servers allocated to transmit parts of a data entity, data part identification key for recognition of data entity parts, data part combination key for combining said data entity parts with each other.

6. The method of claim 1, characterized in that said identities are selected from a larger group of identities.

7. The method of claim 1, characterized in that said identities are changed on a per data message, session or timed basis.

8. The method of claim 1, characterized in that at least one part of a data entity is transmitted to the receiver via a third party assigned by the sender or the receiver.

9. The method of claim 1, characterized in that said parts of a data entity are transmitted to the receiver via at least two different identities of the receiving end, said identities substantially representing at least one of the following types: server, subscription, address, user identifier.

10. The method of claim 1, characterized in that a certificate authenticating the sender is submitted to the receiver by said third party.

11. The method of claim 1, characterized in that during a data transmission session the data or information related thereto is read without having an electrical connection from one device to another.

12. The method of claim 1, characterized in that said communications network is substantially a circuit-switched data network, a packet-switched data network, a telephone network or a mobile phone network.

13. The method of claim 1, characterized in that at least one of said identities is concealed.

14. (canceled)

15. A data transfer medium storing a sequence of instructions that can be interpreted by a computer to perform the method steps of claim 1.

16. A system for encrypting data to be transmitted over a communications network, the system comprising means for data storage (606), means for data processing (610) and means for data transmission (602) between the system and a network element functionally connected with the system, characterized in that the system is arranged to split the data into at least two parts in a fashion substantially unrelated to the data content, the parts being recognizable and connectable with each other by means of key information, and to send the parts independently via different identities, the identities substantially representing at least one of the categories: server, subscription, address, user identifier.

17. The system of claim 16, characterized by including at least some of said different identities.

18. A system for receiving data transmitted over a communications network, the system comprising means for data storage (606), means for data processing (610) and means for data reception (602) between the system and a network element functionally connected with the system, characterized in that it is arranged to receive parts of a data entity transmitted via at least two different identities and split into at least two parts in a fashion substantially unrelated to the data content, said identities substantially belonging to at least one of the types: server, subscription, address, user identifier, and the system further being arranged to recognize and combine said data parts with each other by means of key information.

19. A system for receiving data transmitted over a communications network, the system comprising means for data storage (606), means for data processing (610) and means for data reception (602) between the system and a network element functionally connected with the system, characterized in that the system is arranged to receive parts of a data entity transmitted via at least two different identities and split into at least two parts in a fashion substantially unrelated to the data content, said identities substantially belonging to at least one of the types: server, subscription, address, user identifier, the system further being arranged to recognize and combine said data parts with each other by means of key information, and the system still further being arranged to receive said parts of a data entity via at least two different identities to which identities said data parts are individually directed and which identities substantially belong to at least one of the types: server, subscription, address, user identifier.

20. The system of claim 19, characterized by including at least a portion of said different identities arranged to receive said data parts.

21. The system of claim 19, characterized by having at least one of said identities adapted to store said data part and thereupon to remain waiting for a separate forwarding request of said data part.

22. A method for automated, distributed data storage in an electronic system, characterized in that the method comprises the steps of
splitting (804) a data element to be stored into at least two parts in a fashion substantially unrelated to the data content, and
transferring the data element parts to a storage system for storing the data element parts individually into storage units (806) included in a group of available storage units.

23. The method of claim 22, characterized in that said data transfer comprises a step of transferring at least one part of the data element from said at least two units of the data storage system to a first data storage unit and further another step of transferring at least another one part of the data element to a second data storage unit of the data storage system.

24. The method of claim 22, characterized in that the method further comprises a step of storing at least of one item from the information categories: identifier information for identification of the parts of said data element, location information for retrieval of said data element parts, combination information (808) for combining said data element parts with each other.

25. A system for data storage, the system comprising means for data processing (610) and means for data transfer (602) between the system and a storage system functionally communicating therewith, characterized in that it is arranged to split a data element into at least two parts in a fashion substantially unrelated to the data content and to transfer said data element parts to a storage system for individually storing the data element parts into storage units included in a group of available storage units.

26. The system of claim 25, characterized by having the system equipped with at least two different data storage units thus facilitating the system to transfer at least one part of the data element from said at least two unit of the data storage system to a first data storage unit and further transferring another at least one part of the data element to a second data storage unit of the data storage system.

27. The system of claim 25, characterized by having said system or other equipment functionally connected therewith adapted to store at least of one item from the information categories: identifier information for identification of the parts of said data element, location information for retrieval of said data element parts, combination information for combining said data element parts with each other.

28. The system of claim 1, characterized by having said data storage unit adapted to include at least one of the following storage media: hard disc, diskette station, CD station, memory card, memory circuit.

29. The system of claim 1, characterized by having at least one of said data storage units situated in a server or other network element.

30. The system of claim 26, characterized by having said data storage units located physically apart from each other.
